(19) United States
(12) Patent Application Publication
(10) Pub. No.: US 2026/0366614 A1
(43) Pub. Date: Nov. 19, 2026

(54) AUTOMATIC MULTI-SPEED TRANSMISSIONS

(71) Applicant: Michael C. Argento, Mission Viejo, CA (US)

(72) Inventor: Michael C. Argento, Mission Viejo, CA (US)

(21) Appl. No.: 19/561,253

(22) Filed: Mar. 9, 2026

Related U.S. Application Data
(60) Provisional application No. 63/774,626, filed on Mar. 19, 2025.

(51) Int. Cl. F16H 61/02; B62M 9/04; F16H 9/02

(52) U.S. Cl. CPC F16H 61/0295; B62M 9/04; F16H 9/02; F16H 2200/0021; F16H 2200/0034; F16H 2200/0039

(57) ABSTRACT

The invention is a multi-speed automatic transmission designed for small electric and internal combustion (IC) engine-powered vehicles. It utilizes centrifugal or electric clutches to automatically engage and disengage low-speed and high-speed drives at optimal speeds, ensuring efficient power transfer and maximizing regenerative or engine braking. The transmission is adaptable for two- or three-speed configurations, with electric versions enabling reverse drive through an electric clutch. It allows the engine or motor to gain speed before shifting, improving acceleration and efficiency. Designed for applications such as scooters and motorcycles, the system provides smooth and automatic shifting without the need for manual intervention. The electronic controller ensures precise operation by preventing multiple clutches from engaging simultaneously. By optimizing the transition between speed ranges, the transmission enhances vehicle performance and drivability while maintaining a straightforward and reliable design.

### CROSS REFERENCE TO RELATED APPLICATIONS

This application claims the benefit of Prov. Pat. App. Ser. No. 63/774,626, filed on 2025 Mar. 19, the entire content of which is expressly incorporated herein by reference.

### STATEMENT RE: FEDERALLY SPONSORED RESEARCH/DEVELOPMENT

Not Applicable.

### BACKGROUND

### Field of the Invention

The present invention relates in general to small vehicles and in particular to inexpensive, highly efficient, multi-speed, automatic transmissions for improving the efficiency, and performance of the vehicle.

### Description of Related Art

Automatic multi-speed transmissions like the ones used in internal combustion (I.C.) engine powered vehicles with fluid torque converters, constant mesh gears and corresponding synchromesh rings create a significant amount of drag and would greatly lower the efficiency and performance if used in small I.C. engines or electric powered vehicles. Therefore, it would be desirable to have inexpensive, highly efficient transmissions for small vehicles that would automatically change their speed ratio to keep the I.C. engine or motor of the drive system operating more efficiently.

### BRIEF SUMMARY OF THE INVENTION

The present invention addresses the above and other needs by providing simple, inexpensive, highly efficient, multi-speed automatic transmissions for small electric and I.C. engine powered vehicles. These simple transmissions employ state-of-the-art centrifugal clutches or electric clutches that engage and disengage the low-speed drive and the high-speed drive at the right speed to achieve the highest efficiency during the drive phase, and the greatest amount of compression braking from the I.C. engine or the most generation of electrical energy from the electric motor during the braking phase.

### BRIEF DESCRIPTION OF THE DRAWINGS

Advantages of the present invention will become apparent to those skilled in the art with the benefit of the following detailed description and upon reference to the accompanying drawings in which:

FIGS. 1A and 1B are a cross-section view of the inside of a typical state of the art, bidirectional, centrifugal clutch in the engaged (FIG. 1A) and in the disengaged position (FIG. 1B), which is used to operate a two-speed automatic transmission of the present invention.

FIGS. 2A and 2B are a symbolic drawing of a preferred embodiment of a simple, two-speed automatic transmission of the present invention for a small electric powered vehicle that does not need a reverse drive. It employs a clutch like the clutch in FIGS. 1A and 1B and shows the locations of the components of the low speed drive (FIG. 2A) and high-speed drive (FIG. 2B) with respect to the input and output shafts of the transmission.

FIGS. 3A and 3B show the same transmission as FIGS. 2A and 2B except that it is for a small I.C. engine powered vehicle that does not need a reverse drive. It has an additional centrifugal clutch on the input shaft to allow the engine to gain some speed before engaging the low-speed drive.

FIGS. 4A and 4B are a symbolic drawing of a preferred embodiment of a simple, two-speed automatic transmission of the present invention for a small electric powered vehicle that needs a reverse drive. It employs an electric clutch on the output shaft that is rotationally connected to the low-speed drive.

FIGS. 5A, 5B, 5C show the same transmission as FIG. 4s 4A and 4B except that it is a three-speed automatic transmission with a higher speed drive.

### DETAILED DESCRIPTION OF THE INVENTION

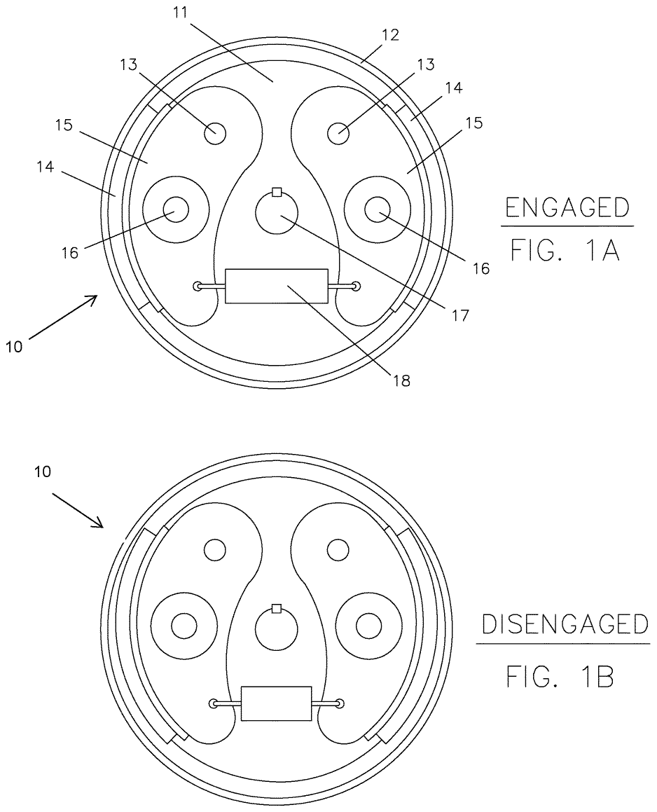

FIGS. 1A and 1B are a cross-section view of the inside of a typical state of the art, bidirectional, centrifugal clutch 10 showing the two shoes 15 with their friction pads 14 firmly attached, mounted on the backing plate 11 with rotation pins 13. The tension spring 18 holds the shoes 15, away from the drum 12 in the disengaged position. When the rotational speed of the shaft 17, which is keyed to the backing plate 11, reaches an amount high enough to create enough centrifugally force the shoes 15 rotate around the pins 13 out against the drum 12 in the engaged position. The friction pads 14 then rotate the drum 12 up to the speed of the backing plate 11 until the rotational speed and the torque on the clutch 10 is reduced enough to release the shoes 15. The drum 12 which is mounted on the input shaft 17 with a bearing (not shown), so that it can rotate on the shaft 17 until the clutch 10 engages. The added weights 16 and the tension spring 18 can be adjusted to change the engagement speed of the clutch 10.

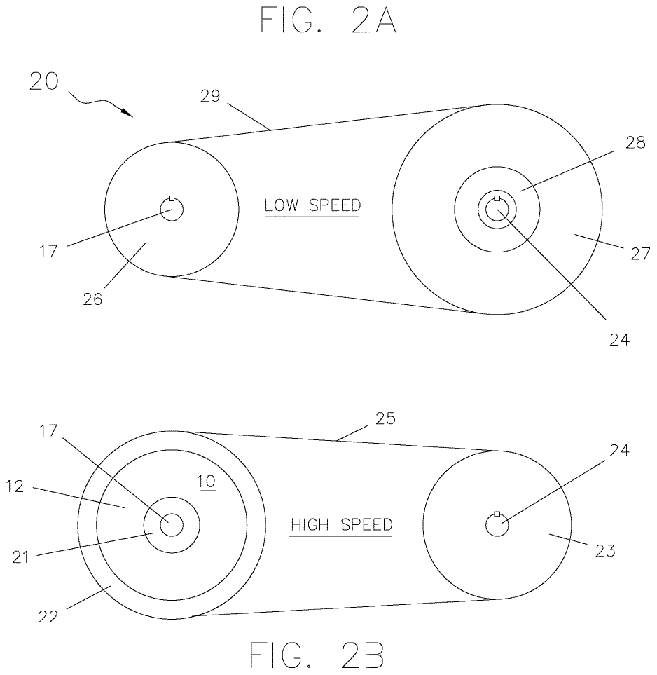

FIGS. 2A and 2B are a symbolic drawing of a preferred embodiment of the present invention. It is a two-speed automatic transmission 20 which can be used in an electric powered vehicle that does not need a reverse drive, for example, a two or three-wheel vehicle, like a scooter or a motorcycle. The low-speed drive (FIG. 2A) consists of a small sprocket or pulley 26 keyed to the input shaft 17, a larger sprocket or pulley 27 mounted on the output shaft 24 with a clutch bearing 28, and a chain or belt 29 rotationally engaging sprocket or pulley 26 with sprocket or pulley 27. This allows the input shaft 17 to drive the output shaft 24 in the forward direction until the centrifugal clutch 10 in the high-speed drive (FIG. 2B) engages. When the clutch 10 engages and the output shaft 24 starts turning faster than the sprocket or pulley 27 the clutch bearing 28 allows the output shaft 24 to keep turning faster.

The drum 12 of the clutch 10 is shown mounted on the input shaft 17 with a bearing 21. A sprocket or pulley 22 is mounted concentrically on the drum 12 and a smaller sprocket or pulley 23 is keyed to the output shaft 24, so that a chain or belt 25 rotationally connects the drum 12 to the output shaft 24. Therefore, when the clutch 10 engages the sprocket or pulley 22 with the input shaft 17, driven by an electric motor (not shown), the motor can then take the output shaft 24 up to a higher speed. The clutch 10 can be mounted the same way on shaft 24 instead of shaft 17 and provide the same function.

In FIG. 1A the shoes 15 and the friction pads 14 are pressed against the inside of the drum 12 in the engaged position at high speed due to the centrifugal force on the shoes 15. But if the electric motor (not shown) is applying reverse torque for slowing down or for descending downward sloping grades at constant speeds, one of the shoes 15 will stay in place and keep the clutch 10 engaged to a lower speed than normal for the following reason. The reverse torque from the motor (not shown) in the braking mode causes a torque on one of the shoes 15 around the rotation pin 13, and forces it against the drum down to a lower speed.

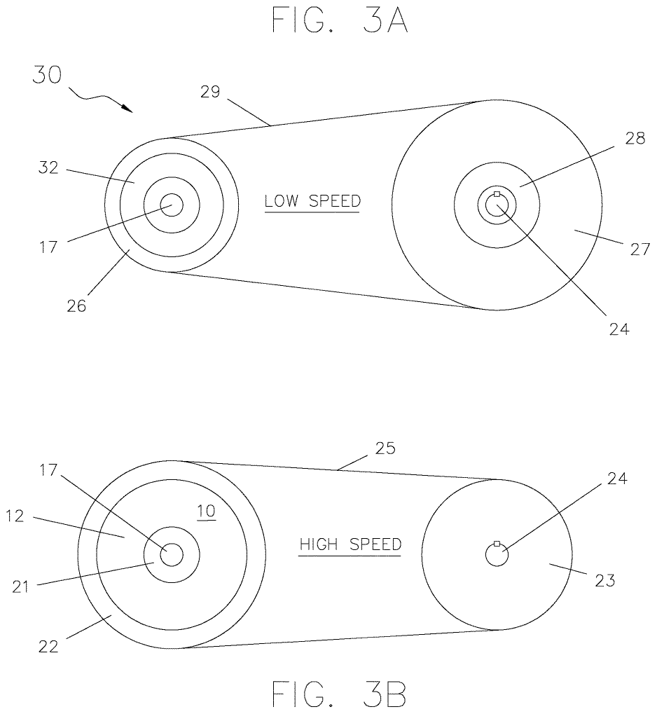

FIGS. 3A and 3B display a similar transmission 30 to the transmission 20 of FIGS. 2A and 2B except that it is for a small I.C. engine powered vehicle. It has a centrifugal clutch assembly 32 on the input shaft in the low gear drive to allow the engine to gain some speed before engaging with the low gear drive. All of the other components can be the same type.

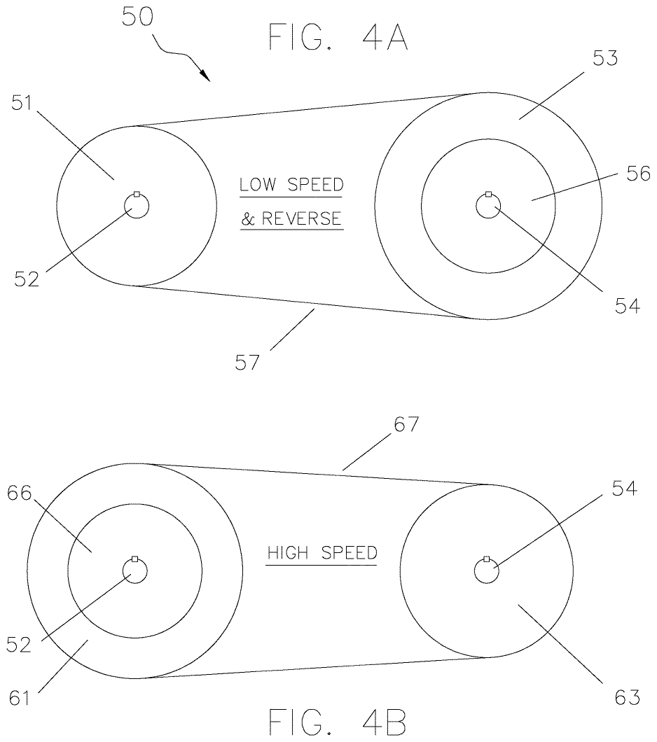

FIGS. 4A and 4B are a symbolic drawing of a preferred embodiment of the present invention. It is a simple, two-speed automatic transmission 50 for a small electric powered vehicles that require a reverse drive. It is similar to transmission 20 in FIGS. 2A and 2B in that it has a low-speed and a high-speed drive, both connected to an input shaft 52 and an output shaft 54. But it is not the same because it has an electric clutch 56 mounted on the output shaft of the low-speed drive in place of the clutch bearing 28, so that when the electric clutch 56 is engaged the electric motor can be run in reverse to drive the vehicle backward. The centrifugal clutch 10 on the input shaft 52 has also been replaced by an electric clutch 66 so that the electronic controller (not shown) would not allow the two clutches 56 and 66 to be engaged at the same time. The clutch 56 in the low-speed drive and the clutch 66 in the high-speed drive can be mounted the same way on either shaft 52 or 54 and provide the same function.

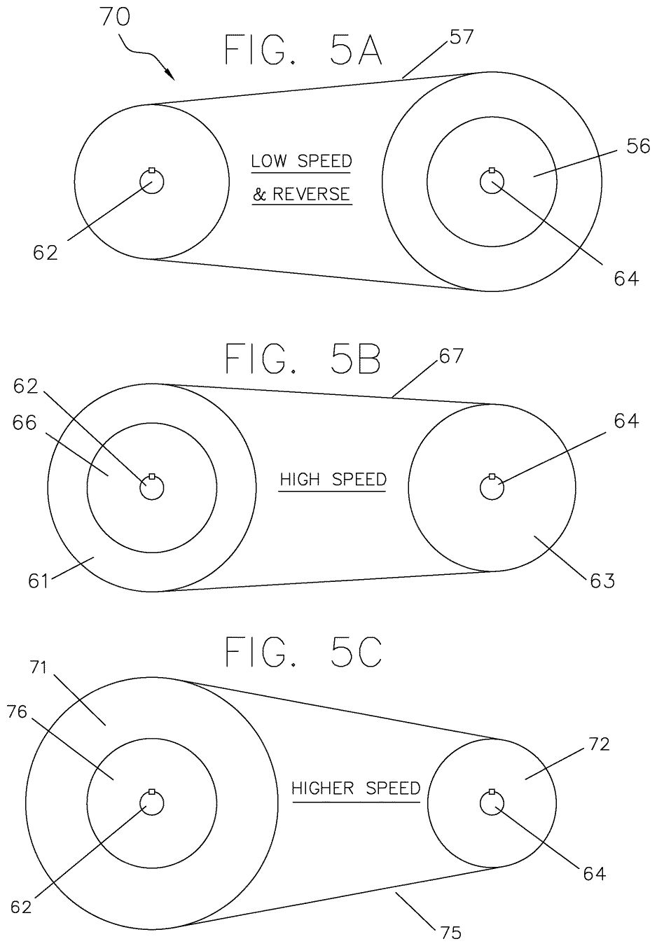

FIGS. 5A, 5B, and 5C display a similar transmission 70 to the transmission 50 of FIGS. 4A and 4B except that a higher speed drive has been added to shafts 62 and 64. The higher speed drive is the same as the other two drives except for the ratio. The electronic controller (not shown) for transmission 70 will not allow any two of the three clutches 56, 66, and 76 to be engaged at the same time.

### Other Variations and Terminology

While the invention herein disclosed has been described by means of specific embodiments and applications thereof, numerous modifications and variations could be made thereto by those skilled in the art without departing from the scope of the invention set forth in the claims.

While certain embodiments have been described, these embodiments have been presented by way of example only and are not intended to limit the scope of protection. It will be understood by those skilled in the art that the present disclosure extends beyond the specifically disclosed embodiments to other alternative embodiments or uses and obvious modifications and equivalents thereof, including embodiments which do not provide all of the features and advantages set forth herein. Furthermore, various omissions, substitutions, and changes in the form of the methods and systems described herein may be made. Those skilled in the art will appreciate that in some embodiments, the actual steps taken in the processes illustrated or disclosed may differ from those shown in the figures. Depending on the embodiment, certain of the steps described above may be removed; others may be added. Accordingly, the scope of the present disclosure is not intended to be limited by the specific disclosures of preferred embodiments herein, and may be defined by claims as presented herein or as presented in the future. The language of the claims is to be interpreted broadly based on the language employed in the claims and not limited to the examples described in the patent specification of during prosecution of the application, which examples are to be construed as non-exclusive.

Features, materials, characteristics, or groups described in conjunction with a particular aspect, embodiment, or example are to be understood to be applicable to any other aspect, embodiment, or example described herein unless incompatible therewith. All of the features disclosed in this specification (including any accompanying claims, abstract, and drawings), or all of the steps of any method or process so disclosed, may be combined in any combination, except combinations where at least some of such features or steps are mutually exclusive. The protection extends to any novel one, or any novel combination, of the features disclosed in this specification (including any accompanying claims, abstract, and drawings), or to any novel one, or any novel combination, of the steps of any method or process so disclosed.

Conditional language, such as “can,” “could,” “might,” or “may,” unless specifically stated otherwise, or otherwise understood within the context as used, is generally intended to convey that certain embodiments include, while other embodiments do not include, certain features, elements, or steps. Thus, such conditional language is not generally intended to imply that features, elements, or steps are in any way required for one or more embodiments. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of the stated amount. As another example, the terms “generally parallel” and “substantially parallel” may refer to a value, amount, or characteristic that departs from exactly parallel by less than 15 degrees.

What is claimed:

1. A two-speed automatic transmission for an electric powered vehicle, the transmission comprising:
a low-speed chain or belt drive configured to drive the vehicle only in the forward direction; and
a high-speed chain or belt drive with a centrifugal clutch configured to engage before the maximum speed of the low-speed drive and can take the vehicle up to a higher speed.

2. A two-speed automatic transmission for an internal combustion (IC) engine powered vehicle, the transmission comprising:
a low-speed chain or belt drive with a centrifugal clutch that engages when the engine gains some speed, and can only drive the vehicle in the forward direction; and
a high-speed chain or belt drive with a centrifugal clutch that engages before the maximum speed of the low-speed drive and can take the vehicle up to a higher speed.

3. A two-speed automatic transmission for an electric powered vehicle, the transmission comprising:
a low-speed chain or belt drive with an electric clutch that disengages before the electric motor reaches full speed; and
a high-speed chain or belt drive with an electric clutch that engages after the clutch in the low-speed drive disengages and can take the vehicle up to a higher speed.

4. A three-speed automatic transmission for an electric powered vehicle, the transmission comprising:
a low-speed chain or belt drive comprising an electric clutch that disengages before the electric motor reaches full speed; and
a high-speed chain or belt drive comprising an electric clutch that can engage right after the low-speed clutch disengages and further configured to take the vehicle up to a higher speed; and
a higher-speed chain or belt drive comprising an electric clutch configured to engage right after the high-speed clutch disengages and further configured to take the vehicle up to an even higher speed.
